(19) United States
(12) Patent Application Publication
(10) Pub. No.: US 2017/0115697 A1
(43) Pub. Date: Apr. 27, 2017

(54) DISPLAY DEVICE

(71) Applicant: Samsung Display Co., Ltd., Yongin-si (KR)

(72) Inventors: Pil Sook KWON, Incheon (KR); Tae Woo LIM, Yongin-si (KR)

(21) Appl. No.: 15/169,228

(22) Filed: Aug. 11, 2016

(30) Foreign Application Priority Data
Aug. 31, 2015 (KR) 10-2015-0122686

(51) Int. Cl. G06F 1/16

(52) U.S. Cl. CPC G06F 1/1641; G06F 1/1626; G06F 1/1677; G06F 1/1647; G06F 1/1652

(57) ABSTRACT

A display device includes a first display, a second display, a first contact, and a second contact. The first display includes a first pixel electrode. The second display includes a second pixel electrode. The first pixel electrode overlaps the second pixel electrode when the display device is in a closed state. A first edge of the first display contacts a first edge of the second display when the display device is in an open state. The first contact contacts a second edge of the first display. The second contact contacts a second edge of the second display. The first contact contacts the second contact when the display device is in the closed state. The first contact is spaced from the second contact and is connected through the first display and the second display to the second contact when the display device is in the open state.

### CROSS-REFERENCE TO RELATED APPLICATION

This application claims priority to and the benefit of Korean Patent Application No. 10-2015-0122686, filed in the Korean Intellectual Property Office on Aug. 31, 2015; the entire contents of the Korean Patent Application are incorporated herein by reference.

### BACKGROUND

(a) Technical Field

The technical field relates to a display device.

(b) Description of the Related Art

A display device, such as a liquid crystal display, may include electric field generating electrodes, such as a pixel electrode and a common electrode, and may include a liquid crystal layer positioned between the electric field generating electrodes.

The liquid crystal display may display an image by applying a voltage to the electric field generating electrodes to control alignments of liquid crystal molecules of the liquid crystal layer for controlling transmission of incident light.

The above information disclosed in this Background section is provided to enhance understanding of the background of this application. This Background section may contain information that does not form the prior art that is already known in this country to a person of ordinary skill in the art.

### SUMMARY

Embodiments may be related to a display device that provides a wide screen and is conveniently portable. An embodiment may be related to a display device. An embodiment of the present invention provides a display device including: a first display unit and a second display unit each having a curvature, wherein the first display unit and the second display unit are connected to each other at a first edge, an opening and closing unit for opening and closing the first display unit and the second display unit is formed at a second edge, and at least one of the first display unit and the second display unit includes a substrate, a pixel electrode provided on the substrate, a roof layer facing the pixel electrode; and a liquid crystal layer formed with a plurality of microcavities including liquid crystal molecules between the pixel electrode and the roof layer.

While the first display unit and the second display unit are closed, the displaying sides of the first display unit and the second display unit may face an internal side, and rear sides of the first display unit and the second display unit may have an externally exposed bag shape.

While the first display unit and the second display unit that face each other are closed, a space may be formed between the first display unit and the second display unit, and an input device may be received in the space.

While the first display unit and the second display unit are opened, a displaying side of the first display unit may be connected to a displaying side of the second display unit to form a displaying side.

A driver may be provided on a first edge connected to the first display unit and the second display unit and a power supply may be provided on the first edge connected to the first display unit and the second display unit.

The driver and the power supply may be formed in a bar shape on the first edge of the first display unit and the second display unit, and the driver and the power supply may become a support for fixing the display device when the first display unit and the second display unit are opened.

First sides of the driver and the power supply may be connected to each other, and the driver may be separated from the power supply with a predetermined angle therebetween to fix the opened first display unit and the second display unit.

The first display unit and the second display unit may be connected to each other on a first edge by a hinge.

The first display unit and the second display unit may further include a common electrode.

The roof layer may form a partition wall portion provided between a liquid crystal layer formed with the microcavities. The display device may include a first display unit, a second display unit, a first contact unit, and a second contact unit. The first display unit may include a first pixel electrode, which may be associated with (and included in) a first pixel of the display device. The second display unit may include a second pixel electrode, which may be associated with (and included in) a second pixel of the display device. The first pixel electrode may overlap the second pixel electrode when the display device is in a closed state of the display device. A first edge of the first display unit may directly contact a first edge of the second display unit when the display device is in an open state of the display device. The first contact unit may directly contact a second edge of the first display unit. The second contact unit may directly contact a second edge of the second display unit. The first contact unit may directly contact the second contact unit when the display device is in the closed state of the display device. The first contact unit may be spaced from the second contact unit and may be connected through the first display unit and the second display unit to the second contact unit when the display device is in the open state of the display device.

The first display unit may include a first liquid crystal layer. The second display unit may include a second liquid crystal layer. The first liquid crystal layer and the second liquid crystal layer may be positioned between the first pixel electrode and the second pixel electrode when the display device is in the closed state.

The display device may include a user-input device, e.g., a keyboard or a mouse. The user-input device may be positioned between the first display unit and the second display unit when the display device is in the closed state.

The second edge of the first display unit may directly contact the second edge of the second display unit when the display device is in the closed state. The second edge of the first display unit may be spaced from the second edge of the second display unit when the display device is in the open state.

The display device may include a driver. The driver may overlap (and may provide control signals) to each of the first edge of the first display unit and the first edge of the second display unit.

The display device may include a power supply. The display device may provide power to at least one of the driver, the first display unit, and the second display unit. The power supply may be oriented parallel to the driver when the display device is in the closed state and may be oriented at an acute angle or a right angle with respect to the driver when the display device is in the open state.

The display device may include a hinge. The first display unit may be connected through the hinge to the second display unit. The driver may be positioned between the hinge and the power supply when the display device is in the closed state.

The power supply may be longer than or as long as at least one of the driver and The first display unit may be curved between the driver and the first contact unit.

The first pixel electrode may be spaced from the second pixel electrode by a first distance when the display device is in the closed state. The first pixel electrode may be spaced from the second pixel electrode by a second distance when the display device is in the open state. The first distance may be less than the second distance.

The first pixel electrode may be spaced from the second pixel electrode by the first distance when the display device is in a first closed mode. The first pixel electrode may be spaced from the second pixel electrode by a third distance when the display device is in a second closed mode. The first distance may be unequal to the third distance.

An embodiment may be related to a display device. The display device may include a hinge, a first display unit, a second display unit, a first contact unit, and a second contact unit. The first display unit may include a first pixel electrode, which may be associated with (and included in) a first pixel of the display device. The second display unit may be connected through the hinge to the first display unit and may include a second pixel electrode, which may be associated with (and included in) a second pixel of the display device. The first pixel electrode may overlap the second pixel electrode when the display device is in a closed state of the display device. The first contact unit may be connected through the first display unit to the hinge. The second contact unit may be connected through the second display unit to the hinge. The first contact unit may directly contact the second contact unit when the display device is in the closed state of the display device. The first contact unit may be spaced from the second contact unit and may be connected through the first display unit and the second display unit to the second contact unit when the display device is in an open state of the display device.

### BRIEF DESCRIPTION OF THE DRAWINGS

FIG. 1 shows a perspective view of a display device in a closed state according to an embodiment.

FIG. 2 shows a side view of a display device in a closed state according to an embodiment.

FIG. 3 shows a perspective view of a display device in an open state according to an embodiment.

FIG. 4 shows a side view of a display device in a closed state according to an embodiment.

FIG. 5 shows a side view of a display device in a closed state according to an embodiment.

FIG. 6 shows a plan view of a structure of a display unit of a display device according to an embodiment.

FIG. 7 shows a cross-sectional view with respect to line VII-VII of FIG. 6.

FIG. 8 shows a cross-sectional view with respect to line VIII-VIII of FIG. 6.

FIG. 9 shows a plan view of a structure of a display unit of a display device according to an embodiment.

FIG. 10 shows a cross-sectional view with respect to line X-X of FIG. 9.

FIG. 11 shows a cross-sectional view with respect to line XI-XI of FIG. 9.

### DETAILED DESCRIPTION OF THE EMBODIMENTS

Embodiments are described with reference to the accompanying drawings. As those skilled in the art would realize, the described embodiments may be modified in various different ways.

Although the terms “first”, “second”, etc. may be used herein to describe various elements, these elements should not be limited by these terms. These terms may be used to distinguish one element from another element. Thus, a first element recited in this application may be termed a second element without departing from embodiments. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

If a first element (such as a layer, film, region, or substrate) is referred to as being “on”, “neighboring”, “connected to”, or “coupled with” a second element, then the first element can be directly on, directly neighboring, directly connected to, or directly coupled with the second element, or an intervening element may also be present between the first element and the second element. If a first element is referred to as being “directly on”, “directly neighboring”, “directly connected to”, or “directed coupled with” a second element, then no intervening element (except environmental elements such as air) may be intended between the first element and the second element.

Spatially relative terms, such as “beneath”, “below”, “lower”, “above”, “upper”, and the like, may be used herein for ease of description to describe one element or feature's spatial relationship to another element(s) or feature(s) as illustrated in the figures. It will be understood that the spatially relative terms may encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein should be interpreted accordingly.

The terminology used herein is for the purpose of describing particular embodiments and is not intended to limit the embodiments. As used herein, the singular forms, “a”, “an”, and “the” may indicate plural forms as well, unless the context clearly indicates otherwise. The terms “includes” and/or “including”, when used in this specification, may specify the presence of stated features, integers, steps, operations, elements, and/or components, but may not preclude the presence or addition of one or more other features, integers, steps, operations, elements, components, and/or groups.

Unless otherwise defined, terms (including technical and scientific terms) used herein have the same meanings as commonly understood by one of ordinary skill in the art. Terms, such as those defined in commonly used dictionaries, should be interpreted as having meanings that are consistent with their meanings in the context of the relevant art and should not be interpreted in an idealized or overly formal sense unless expressly so defined herein.

The term “connect” may mean “directly connect”, “indirectly connect”, or “electrically connect”. The term “insulate” may mean “electrically insulate”. The term “conductive” may mean “electrically conductive”. The term “electrically connected” may mean “electrically connected without any intervening transistors” or “electrically connected through no intervening transistors”.

In the drawings, the thickness of layers, films, panels, regions, etc., may be exaggerated for clarity. Like reference numerals may designate like elements.

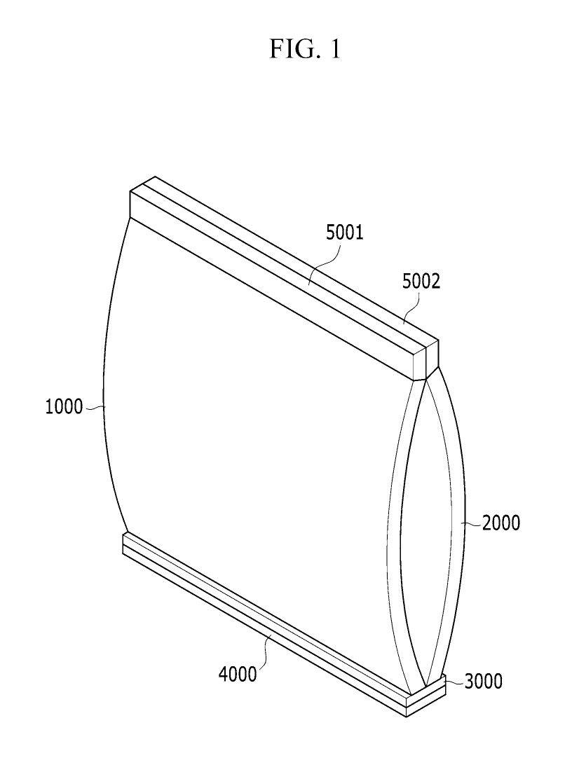

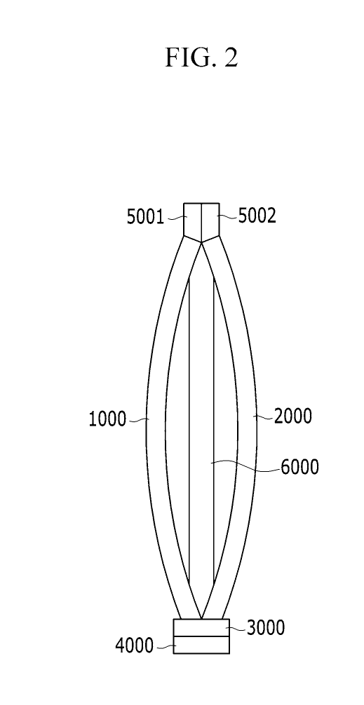

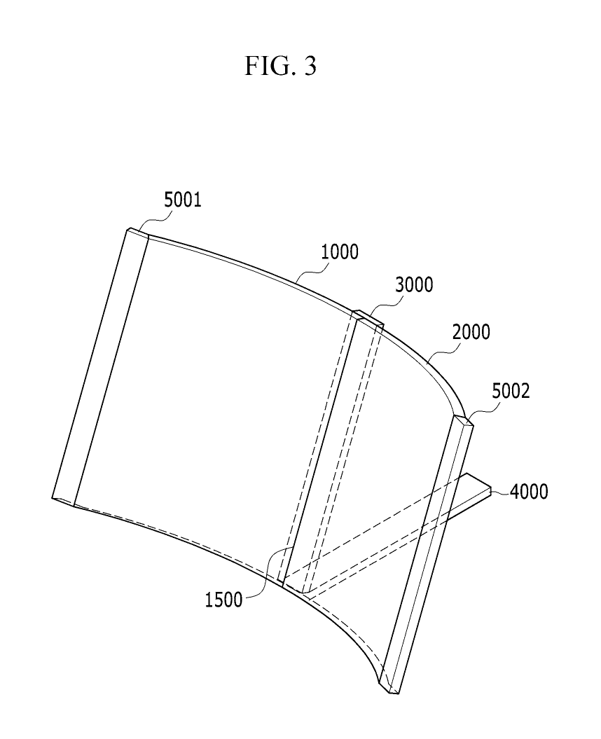

FIG. 1 shows a schematic perspective view of a display device in a closed state according to an embodiment. FIG. 2 shows a side view of the display device in the closed state according to an embodiment. FIG. 3 shows a perspective view of the display device in an open state according to an embodiment.

Referring to FIG. 1 to FIG. 3, the display device includes a first display unit 1000 and a second display unit 2000, which are provided to face each other in the closed state and are curved to each have a predetermined curvature.

First edges of the first display unit 1000 and the second display unit 2000 are connected to each other. Contact units 5001 and 5002 (or coupling units 5001 and 5002) are respectively positioned at second edges of the display units 1000 and 2000 and may directly contact (and engage) each other or may be spaced from each other according to states (e.g., a closed state and an opening state) of the display device.

A knob may be formed on the contact units 5001 and 5002.

Referring to FIG. 1, a driver 3000 and a power supply 4000 are formed on a first edge of the first display unit 1000 and a first edge of the second display unit 2000, which are connected to each other.

The first display unit 1000 and the second display unit 2000 are curved to each have a predetermined curvature so that when the display device is closed, a space is formed between the display units 1000 and 2000.

An input device 6000 may be housed in the space between the first display unit 1000 and the second display unit 2000.

The display device will now be described in detail.

Regarding the display device according to an embodiment, the first display unit 1000 and the second display unit 2000 are each curved with a predetermined curvature. First edges of the first display unit 1000 and the second display unit 2000 are connected to each other.

A displaying side is formed on an internal side of the first display unit 1000, and a displaying side is formed on an internal side of the second display unit 2000. In this case, the displaying side of the first display unit 1000 is connected to the displaying side of the second display unit 2000 so as to face each other.

Therefore, a predetermined space is formed between the first display unit 1000 and the second display unit 2000 due to the curvature of the display units.

It is desirable for the curvature of the first display unit 1000 to correspond to the curvature of the second display unit 2000. This is because they are connected to each other to form a larger curved displaying side when the first display unit 1000 and the second display unit 2000 are opened.

The first display unit 1000 and the second display unit 2000 are configured with a substrate, a roof layer facing the substrate, and a liquid crystal layer formed between the substrate and the roof layer. That is, the first display unit 1000 and the second display unit 2000 represent display devices formed of a single substrate with microcavities. The above-configured first display unit 1000 and the second display unit 2000 are advantageous in forming a curve compared to a display device formed with two substrates. A pixel configuration of the first display unit 1000 and the second display unit 2000 will be described in detail in a later portion of the specification.

As described, the substrates of the first display unit 1000 and the second display unit 2000 may be bent to each have a predetermined curvature. Alternately, the substrates of the first display unit 1000 and the second display unit 2000 may be flexible.

The first display unit 1000 and the second display unit 2000 are bent to each have a curvature, a displaying side is formed on each internal side, and the displaying sides are combined to face each other.

Referring to FIG. 1 and FIG. 3, first edges of the first display unit 1000 and the second display unit 2000 are connected to each other. In this case, the first display unit 1000 and the second display unit 2000 may be connected by a hinge 1500.

A driver 3000 is formed at a lower portion of the hinge 1500.

The driver 3000 may have a rectangular rod, and a length of the driver 3000 may correspond to a length of the first edge of the first display unit 1000 and/or a length of the first edge of the second display unit 2000.

The driver 3000 may include a storage device and a central processing unit (CPU) and may be configured to provide control signals for driving the first display unit 1000 and the second display unit 2000.

The driver 3000 may include devices for driving a conventional computer. That is, when the driver 3000 includes a hard disk drive and a CPU for a computer, the display device may be used as a laptop computer.

A power supply 4000 may be formed at a lower portion of the hinge 1500. The power supply 4000 may include a battery to supply power to the display device. The shape of the power supply 4000 may correspond to the shape of the driver 3000. That is, the power supply 4000 may have a rectangular bar shape, and the length of the power supply 4000 may correspond to the length of a first edge to which the first display unit 1000 and the second display unit 2000 are connected.

It is shown in the present embodiment that the power supply 4000 is formed at a lower portion of the driver 3000, but the driver 3000 may be formed at a lower portion of the power supply 4000.

As shown in FIG. 1 and FIG. 3, an embodiment relates to a display device that can be closed and opened like a briefcase and has curved sides. The driver 3000 and the power supply 4000 may form an angled support structure for supporting the display units 1000 and 2000 when the display device so is opened (for displaying images).

Referring to FIG. 3, first edges of the driver 3000 and the power supply 4000 may be connected to each other.

That is, the first edges of the driver 3000 and the power supply 4000 may be connected to each other and may spread so that the driver 3000 and the power supply 4000 may form a predetermined angle.

The driver 3000 and the power supply 4000 function as a support structure when the display device is opened to function as a wide display device.

Referring to FIG. 3, the opened first display unit 1000 and the second display unit 2000 realizes a combined wide image displaying side, and the driver 3000 and the power supply 4000 are spread at a predetermined angle to support the wide displaying side at the predetermined angle with respect to a surface (e.g., a level surface) on which the display deice is disposed).

The angle formed by the driver 3000 and the power supply 4000 are controllable, and a user may control the angle of the wide displaying side with respect to the surface by controlling the angle formed by the driver 3000 and the power supply 4000.

Contact units 5001 and 5002 are positioned at edges of the first display unit 1000 and the second display unit 2000 that meet (i.e., have a reduced distance) when the display device is in a closed state. Although not shown in FIG. 1, a knob may be formed on the contact units 5001 and 5002. Therefore, the bag-type display device according to the present embodiment may be easily carried.

The contact units 5001 and 5002 may directly contact (and engage) each other direct collision between the display unit 1000 and the display unit 2000 may be prevented and/or such that the first display unit 1000 and the second display unit 2000 may be securely coupled to each other when the display device is in a closed state.

According to an embodiment, both the first display unit 1000 and the second display unit 2000 are curved, so that a space is formed between (the image displaying side of) the first display unit 1000 and (the image displaying side of) the second display unit 2000 when the display device is closed.

An input device 6000 is received in the space. The input device 6000 may include at least one of a wired keyboard and a wired mouse. Alternately, it may include at least one of a wireless keyboard and a wireless mouse. When the input device is a wireless keyboard and a wireless mouse, a terminal for receiving a radio signal may be formed on the driver 3000.

According to an embodiment, the curved first display unit and the second display unit are connected and hinged like two parts of a briefcase, the driver and the power supply are provided to a portion corresponding to the lower portion of the briefcase, and the input device is received in a space corresponding to an inner space of the briefcase.

When not in use, the display device can be closed to enhance portability. When in use, the display device can be opened to expose a combined wide screen formed by the image displaying sides of the first display unit and the second display unit, the display units can be supported by an angled support structure formed by the driver and the power supply, and the previously-concealed input device may be taken out and used.

According to an embodiment, the combined wide curved screen may provide substantially immersive and/or satisfactory user viewing experience.

According to an embodiment, the first display unit 1000 and the second display unit 2000 are formed to each have a fixed constant curvature.

According to an embodiment, the first display unit 1000 and the second display unit 2000 may be flexible, and the curvatures of the first display unit 1000 and the second display unit 2000 may be adjustable.

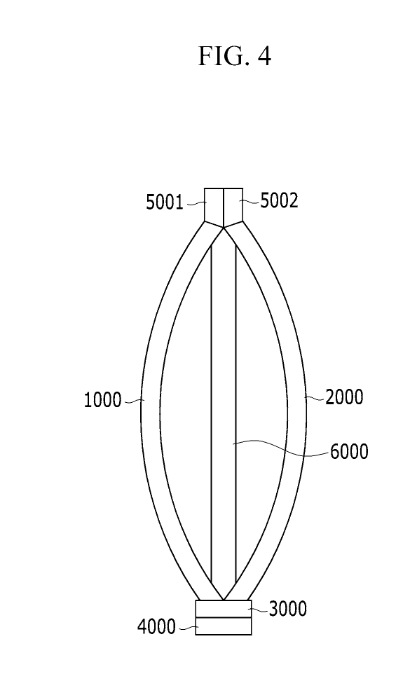

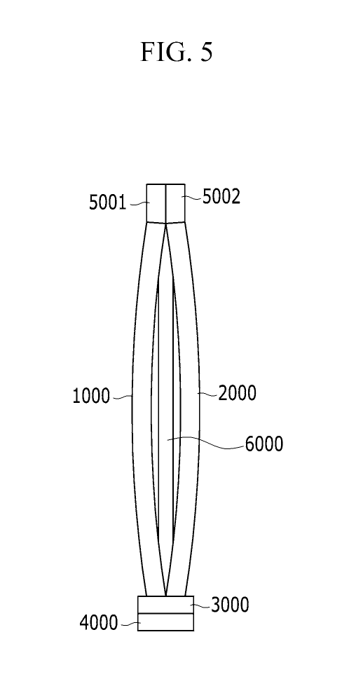

FIG. 4 and FIG. 5 show a display device according to an embodiment.

Referring to FIG. 4, the display units 1000 and 2000 of the display device may be adjusted to have larger curvatures. Therefore, the user may view a more curved combined screen if desirable.

Referring to FIG. 5, the display units 1000 and 2000 of the display device may be adjusted to have smaller curvatures. In this case, more users may view the combined screen simultaneously.

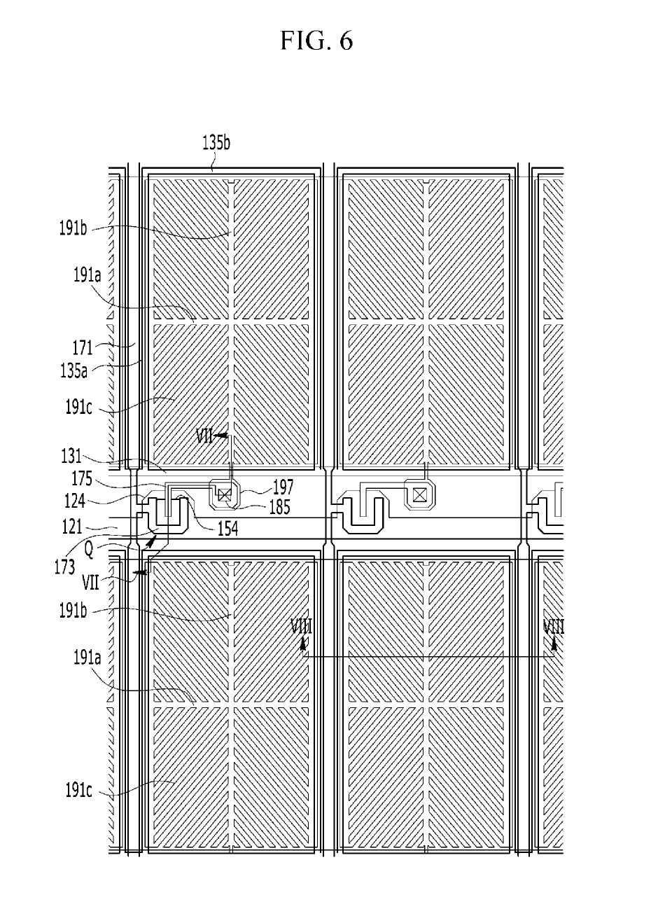

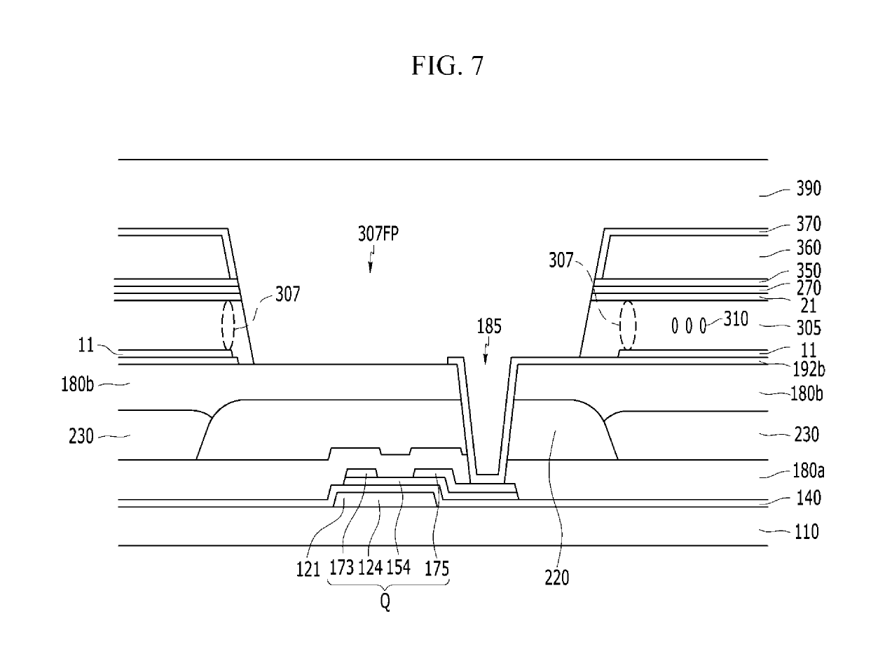

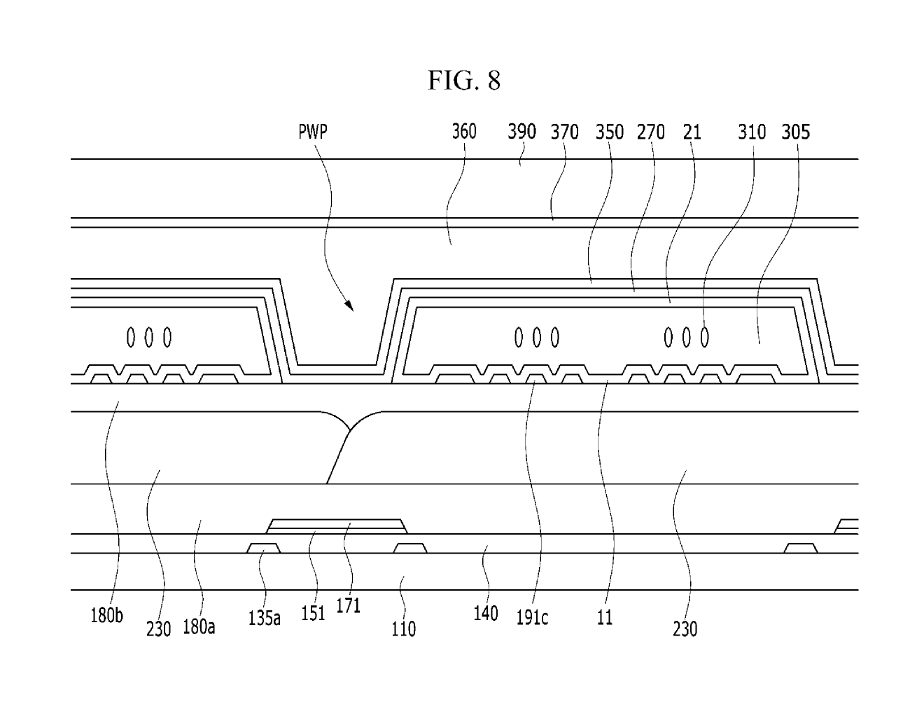

FIG. 6 shows a plan view of a structure of a display unit (e.g., the display unit 1000 or the display unit 2000) of a display device according to the other embodiment. That is, the display unit may include the pixel shown in FIG. 6 and may include a plurality of pixel rows and pixel columns. FIG. 7 shows a cross-sectional view with respect to line VII-VII of FIG. 6. FIG. 8 shows a cross-sectional view with respect to line VIII-VIII of FIG. 6.

Referring to FIG. 6 to FIG. 8, a gate line 121 and a storage electrode line 131 are formed on a substrate 110 made of transparent plastic.

The substrate 110 may be formed of transparent plastic. The substrate 110 may be made of polyimide and may be formed of a material that may be bent or folded in a flexible manner.

The gate line 121 includes a gate electrode 124. The storage electrode line 131 generally extends in a horizontal direction and transmits a predetermined voltage such as a common voltage Vcom. The storage electrode line 131 includes a pair of vertical units 135a, which extend substantially vertically to the gate line 121, and a horizontal unit 135b for connecting ends of the pair of vertical units 135a. The storage electrodes 135a and 135b surround the pixel electrode 191.

A gate insulating layer 140 is formed on the gate line 121 and the storage electrode line 131. A semiconductor layer 151 provided on a lower portion of the data line 171 and a semiconductor layer 154 provided on a lower portion of source/drain electrodes and a channel of a thin film transistor Q are formed on the gate insulating layer 140.

A plurality of ohmic contacts may be formed on the semiconductor layers 151 and 154 and among the data line 171 and the source/drain electrodes, which is omitted in the drawing.

Data conductors 171, 173, and 175, including a source electrode 173 and a data line 171 and a drain electrode 175 connected to the source electrode 173, are formed on the semiconductor layers 151 and 154 and the gate insulating layer 140.

The gate electrode 124, the source electrode 173, and the drain electrode 175 form a thin film transistor Q together with the semiconductor layer 154, and a channel of the thin film transistor Q is formed on the semiconductor layer 154 between the source electrode 173 and the drain electrode 175.

A first interlayer insulating layer 180a is formed on the data conductors 171, 173, and 175 and the exposed part of the semiconductor layer 154

The first interlayer insulating layer 180a may include an inorganic insulator or an organic insulator such as silicon nitride (SiNx) or silicon oxide (SiOx).

A light blocking member 220 is formed on the first interlayer insulating layer 180a.

The light blocking member 220 is horizontally formed parallel to the gate line and is formed of a material through which light cannot be transmitted.

Although omitted in the drawing, the light blocking member 220 may further include a vertical light blocking member formed parallel to the data line 171. In the present embodiment, the data line 171 instead of the vertical light blocking member performs a similar function as the light blocking member.

Color filters 230 may contact side surfaces of the light blocking member 220.

The color filter 230 may display one of the primary colors, including red, green, and blue. However, the colors are not limited to the three primary colors red, green, and blue, and the color filter 230 may also display one among a cyan-based color, a magenta-based color, a yellow-based color, and a white-based color. The color filter 230 may be formed of materials displaying different colors for each adjacent pixel.

A second interlayer insulating layer 180b is formed on the light blocking member 220 and the color filter 230. The second interlayer insulating layer 180b may include an inorganic insulator or an organic insulator such as a silicon nitride (SiNx) or a silicon oxide (SiOx).

A contact hole 185 for exposing the drain electrode 175 is formed on the color filter 230, the light blocking member 220, and the interlayer insulating layers 180a and 180b.

A pixel electrode 191 is formed on the second interlayer insulating layer 180b.

The pixel electrode 191 has a quadrangular shape and includes a cross-shaped stem, including a horizontal stem 191a and a vertical stem 191b that cross. Further, the pixel electrode 191 is divided into four sub-regions by the horizontal stem 191a and the vertical stem 191b, and each sub-region includes a plurality of fine branches 191c. In addition, the sub-region may further include an outer stem for surrounding the pixel electrode 191.

The fine branches 191c of the pixel electrode 191 have an angle of substantially 40 to 45 degrees with respect to the gate line 121 or the horizontal stem. The fine branches of the two neighboring sub-regions may be orthogonal to each other. Further, the width of the fine branches may gradually increase or a gap between the fine branches 191c may be different.

The pixel electrode 191 is connected to a bottom of the vertical stem 191b, includes an extension 197 that is wider than the vertical stem 191b, is physically and electrically connected to the drain electrode 175 through the contact hole 185 at the extension 197, and receives a data voltage from the drain electrode 175.

The above descriptions of the thin film transistor (Q) and the pixel electrode 191 are examples, and the configuration of the thin film transistor and the design of the pixel electrode may vary to improve lateral visibility.

A first alignment layer 11 may be formed on the pixel electrode 191 and may be a vertical alignment layer. The first alignment layer 11 may be formed by including at least one of the materials that are generally used for a liquid crystal alignment layer, such as polyamic acid, polysiloxane, or polyimide.

A second alignment layer 21 is provided on a portion facing the first alignment layer 11, and a microcavity 305 is formed between the first alignment layer 11 and the second alignment layer 21. The first alignment layer 11 is connected to the second alignment layer 21 on a side of the microcavity so they may substantially be one alignment layer.

A liquid crystal material including liquid crystal molecules 310 is injected into the microcavity 305 including an inlet 307. The microcavity 305 may be formed in a column direction of the pixel electrode 191, that is, the vertical direction. The alignment material for forming the alignment layers 11 and 21 and the liquid crystal material including the liquid crystal molecules 310 may be injected into the microcavity 305 by using a capillary force.

The microcavity 305 is divided in the vertical direction by a plurality of liquid crystal injection hole forming regions 307FP provided at a portion overlapping the gate line 121, and a plurality of microcavities are formed in a direction in which the gate line 121 extends. The microcavities 305 may correspond to one or more pixel areas which may correspond to a region that displays a screen.

A common electrode 270 and a lower insulating layer 350 are provided on the second alignment layer 21. The common electrode 270 receives the common voltage and generates an electric field together with the pixel electrode 191 to which the data voltage is applied to determine a direction in which the liquid crystal molecules 310 provided in the microcavity 305 between the two electrodes are slanted. The common electrode 270 forms a capacitor together with the pixel electrode 191, and maintains the voltage when the thin film transistor is turned off. The lower insulating layer 350 may be formed of a silicon nitride (SiNx) or a silicon oxide (SiO₂).

The common electrode 270 has been described to be provided in the microcavity 305 in the present embodiment, and it is also possible for the common electrode 270 to be formed at a lower part of the microcavity 305 and be liquid crystal driven according to a coplanar electrode (CE) mode in another embodiment.

A roof layer 360 is provided on the lower insulating layer 350. The roof layer 360 performs a support function to maintain the microcavity 305 that is a space between the pixel electrode 191 and the common electrode 270. The roof layer 360 may include a photoresist or another organic material.

An upper insulating layer 370 is provided on the roof layer 360. The upper insulating layer 370 may contact a top side of the roof layer 360. The upper insulating layer 370 may be formed of a silicon nitride (SiNx) or a silicon oxide (SiO₂).

The capping layer 390 fills the liquid crystal injection hole forming region 307FP and covers a liquid crystal inlet 307 of the microcavity 305 exposed by the liquid crystal injection hole forming region 307FP. The capping layer 390 includes an organic material or an inorganic material.

As shown in FIG. 8, a partition wall portion (PWP) is formed between the microcavities 305 neighboring in the horizontal direction. The partition wall portion (PWP) may be formed in a direction in which the data line 171 is extended, and it may be covered by the roof layer 360. The partition wall portion (PWP) is filled with the lower insulating layer 350, the common electrode 270, and the roof layer 360, and such a structure forms a partition wall and divides or defines the microcavity 305. Since a partition wall structure such as the partition wall portion (PWP) is provided between the microcavities 305, less stress may be generated when the first display unit and the second display unit are bent, and the bending degree of the cell gap may be substantially reduced.

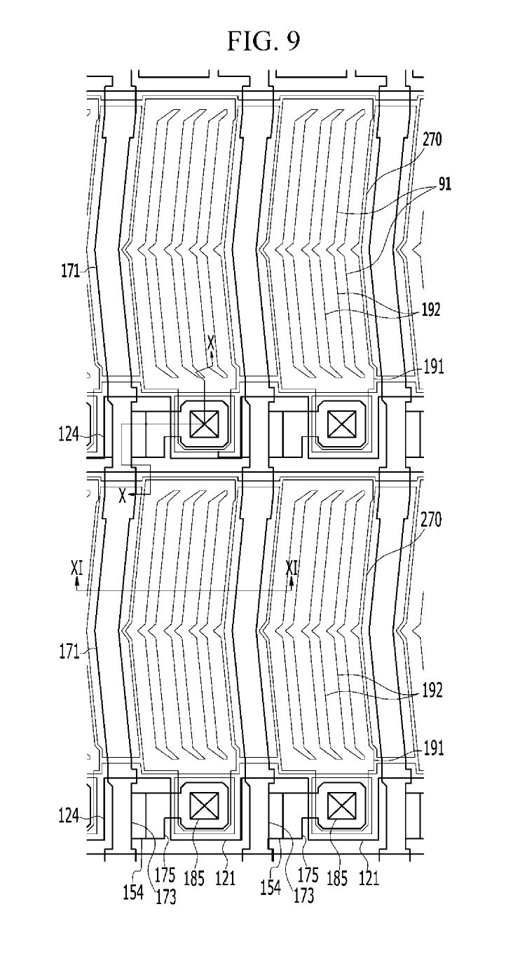

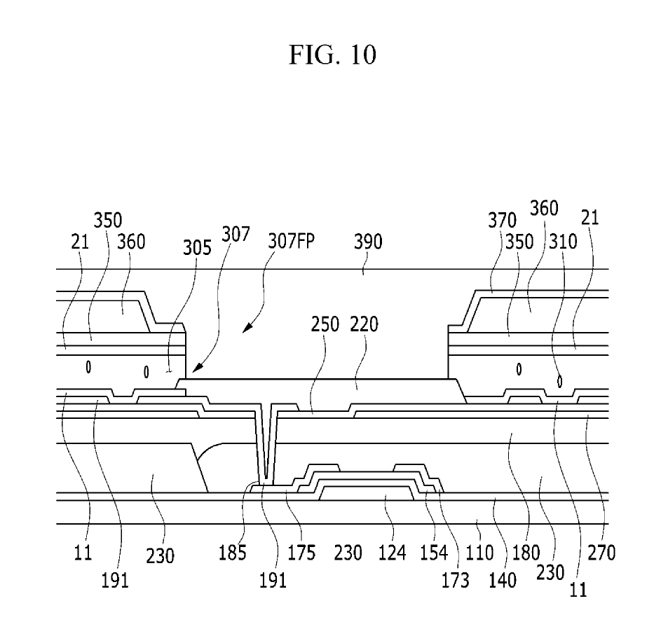

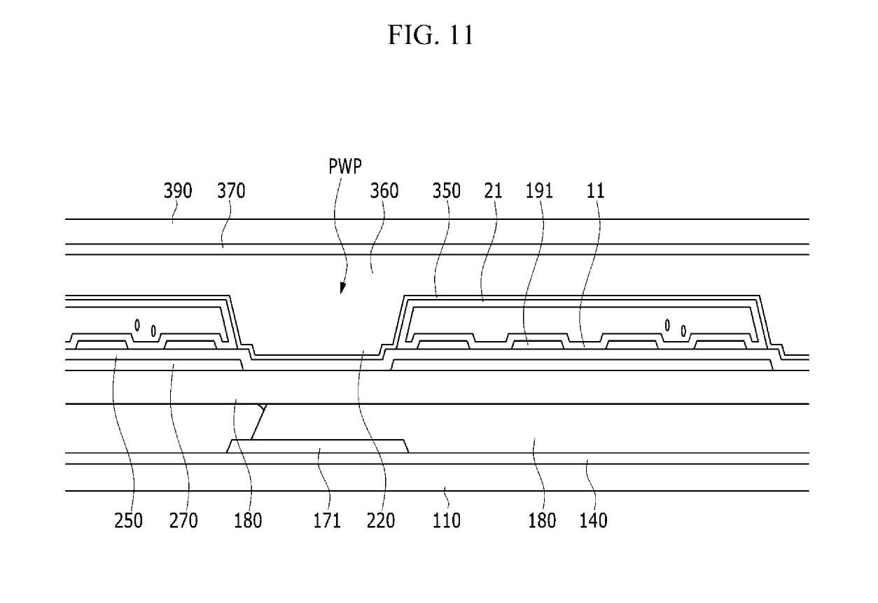

The display unit of a display device according to an embodiment may have a structure to be described below. FIG. 9 shows a plan view of a structure of a display unit of a display device according to an embodiment. FIG. 10 shows a cross-sectional view with respect to line X-X of FIG. 9. FIG. 11 shows a cross-sectional view with respect to line XI-XI of FIG. 9.

A gate conductor including the gate line 121 is formed on the insulation substrate 110 made of transparent plastic.

The gate line 121 includes a wide end portion (not shown) for connection with the gate electrode 124 and another layer or an external driving circuit. The gate line 121 may be made of aluminum-based metals, such as aluminum (Al) and aluminum alloy, silver-based metals, such as silver (Ag) and silver alloy, copper-based metals, such as copper (Cu) and copper alloy, molybdenum-based metals, such as molybdenum (Mo) or molybdenum alloy, chromium (Cr), tantalum (Ta), titanium (Ti), and the like. However, the gate line 121 may have a multilayer structure including at least two conductive layers having different physical properties.

A gate insulating layer 140 made of a silicon nitride (SiNx) or a silicon oxide (SiOx) is formed on the gate line 121. The gate insulating layer 140 may also have a multilayer structure including at least two insulating layers having different physical properties.

A semiconductor layer 154 made of amorphous silicon or polysilicon is formed on the gate insulating layer 140. The semiconductor layer 154 may include an oxide semiconductor.

An ohmic contact (not shown) is formed on the semiconductor layer 154. The ohmic contact (not shown) may be made of materials like n+hydrogenated amorphous silicon, which is highly doped with an n-type impurity, such as phosphorous, at a high concentration or may be made of silicide. A pair of ohmic contacts (not shown) may be disposed on the semiconductor layer 154. When the semiconductor layer 154 is an oxide semiconductor, the ohmic contact may be omitted.

A data line 171 including a source electrode 173 and a data conductor including a drain electrode 175 are formed on the semiconductor layer 154 and the gate insulating layer 140.

The data line 171 includes a wide end portion (not shown) for connection with another layer or an external driving circuit. The data line 171 transmits data signals and mainly extends in a vertical direction to cross the gate lines 121.

In this case, the data line 171 may have a first curved portion having a curved shape to obtain maximum transmittance of the liquid crystal display, in which the first curved portion may have a V-shape by meeting at the middle of a pixel area.

The source electrode 173 is part of the data line 171 and is disposed on the same line as the data line 171. The drain electrode 175 is formed to extend parallel to the source electrode 173. Therefore, the drain electrode 175 is parallel to part of the data line 171.

The gate electrode 124, the source electrode 173, and the drain electrode 175 form a thin film transistor (TFT) together with the semiconductor 154, and a channel of the thin film transistor is formed on the semiconductor 154 between the source electrode 173 and the drain electrode 175.

The data line 171 and the drain electrode 175 can be made of a refractory metal such as molybdenum, chromium, tantalum, and titanium, or an alloy thereof, and they can have a multilayer structure including a refractory metal film (not shown) and a low-resistance conductive layer (not shown). Examples of the multilayered structure may include a double layer including a chromium or molybdenum (alloy) lower layer and an aluminum (alloy) upper layer, and a triple layer including a molybdenum (alloy) lower layer, an aluminum (alloy) intermediate layer, and a molybdenum (alloy) upper layer. However, the data line 171 and the drain electrode 175 may be made of various metals or conductors in addition to the aforementioned materials.

The color filter 230 is formed on the data conductors 171, 173, and 175, the gate insulating layer 140, and the pixel area PX on the exposed portion of the semiconductor layer 154. Each color filter 230 may display one primary color, such as the three primary colors of red, green, and blue. The color filter 230 is not limited to the three primary colors of red, green, and blue and may also display cyan, magenta, yellow, white-based colors, and the like.

A passivation layer 180 is disposed on the color filter 230. The passivation layer 180 may be formed of an organic insulating material or an inorganic insulating material.

The passivation layer 180 and the color filter 230 have a contact hole 185.

A common electrode 270 is provided on the passivation layer 180. The common electrode 270 may be a plane shape, is provided in the display area in which the plurality of pixels are provided, and is not provided in a peripheral area in which a gate pad and a data pad are formed.

The common electrode 270 is formed of a transparent conductive layer made of ITO or IZO.

An insulating layer 250 is disposed on the common electrode 270. The insulating layer 250 may be made of inorganic insulating materials such as a silicon nitride (SiNx), a silicon oxide (SiOx), and a silicon nitride oxide (SiOxNy). The insulating layer 250 serves to protect the color filter 230 made of the organic material and insulate the common electrode 270 and the pixel electrode 191. That is, when the common electrode 270 is formed to overlap the pixel electrode 191, the insulating layer 250 is formed on the common electrode 270 and therefore the common electrode 270 and the pixel electrode 191 may be prevented from being short-circuited with each other due to contact with each other.

The pixel electrode 191 is disposed on the insulating layer 250. The pixel electrode 191 includes a plurality of first cutouts 91 and includes a plurality of first branch electrodes 192 defined by the first cutouts 91.

The pixel electrode 191 is made of a transparent conductive layer such as ITO or IZO.

The pixel electrode 191 is physically and electrically connected to the drain electrode 175 through the contact hole 185 formed in the passivation layer 180 to receive a voltage from the drain electrode 175.

The pixel electrode 191 receives a data voltage from the drain electrode 175, and the common electrode 270 receives a predetermined reference voltage from a reference voltage applying unit disposed outside the display area.

The pixel electrode 191 and the common electrode 270 generate an electric field according to the applying voltage, and the liquid crystal molecules 3100 of the liquid crystal layer provided on the electrodes 191 and 270 rotate parallel to the direction of the electric field. The polarization of light passing through the liquid crystal layer is changed depending on the rotating direction of the liquid crystal molecules determined as described above.

A lower insulating layer 350 may be further formed on the pixel electrode 191 so that it is spaced apart from the pixel electrode 191 at a predetermined distance. The lower insulating layer 350 may be made of inorganic insulating materials such as a silicon nitride (SiNx) or a silicon oxide (SiOx).

A microcavity 305 is formed between the pixel electrode 191 and the lower insulating layer 350. That is, the microcavity 305 is enclosed with the pixel electrode 191 and the lower insulating layer 350. The width and area of the microcavity 305 may vary depending on the size and resolution of the display device.

A first alignment layer 11 is formed on the pixel electrode 191. The first alignment layer 11 may also be formed only on the lower insulating layer 250, which is not covered by the pixel electrode 191.

The second alignment layer 21 is formed under the lower insulating layer 350 to face the first alignment layer 11.

The first alignment layer 11 and the second alignment layer 21 may be formed of a vertical alignment layer and may be made of an alignment material such as polyamic acid, polysiloxane, and polyimide. As shown in FIG. 11, the first and second alignment layers 11 and 21 may be connected to each other at the edge of the pixel area PX.

A liquid crystal layer including liquid crystal molecules 310 is formed in the microcavity 305 provided between the pixel electrode 191 and the lower insulating electrode 350.

A light blocking member 220 is formed parallel to the gate line, and particularly, as shown in FIG. 10, it may be provided on the insulating layer 250 not covered by the pixel electrode 191 and the pixel electrode. The light blocking member 220 may be formed on the edge of the pixel area PX and the thin film transistor to prevent light leakage.

The light blocking member 220 extends along the gate line 121, and it may include a vertical light blocking member extending along the data line 171. That is, the horizontal light blocking member may be formed in the liquid crystal injection hole forming region 307FP, and the vertical light blocking member may be formed on the partition wall portion (PWP). The vertical light blocking member may be omitted. The width of the data line 171 may be increased so that the data line 171 may function as a vertical light blocking member.

A roof layer 360 is formed on the lower insulating layer 350. The roof layer 360 may be made of an organic material. A microcavity 305 is formed under the roof layer 360 and the roof layer 360 becomes hard by a hardening process to maintain the shape of the microcavity 305. The roof layer 360 is formed to be separated from the pixel electrode 191; the microcavity 305 may be positioned between the roof layer 360 and the pixel electrode 191.

The roof layer 360 is formed in the pixel area PX and on the partition wall part PWP along the pixel row, and is not formed in the liquid crystal injection hole forming area 307FP. The microcavity 305 is not formed below the roof layer 360 regarding the partition wall portion (PWP). Therefore, the roof layer 360 provided on the partition wall portion (PWP) may be formed to be thicker than the roof layer 360 provided in the pixel area. An upper side and respective lateral sides of the microcavity 305 are formed to be covered by the roof layer 360.

An inlet 307 for exposing part of the microcavity 305 is formed at the roof layer 360. The lower insulating layer 350 adjacent to a region where the inlet 307 is formed may include a region protruding further than the roof layer 360.

The inlet 307 may be formed on a first edge of the pixel area PX. For example, the inlet 307 may be formed to expose one side of the microcavity 305, corresponding to a lower side of the pixel area PX. On the contrary, the inlet 307 may be formed to correspond to an upper side of the pixel area PX.

Further, regarding the formation position of the inlet 307 based on the microcavity 305, the inlet 307 may be formed at any one or both of the two edges of microcavity 305 which face each other.

The microcavity 305 is exposed by the inlet 307 so an aligning agent or a liquid crystal material may be injected into the microcavity 305 through the inlet 307.

An upper insulating layer 370 may be further formed on the roof layer 360. The upper insulating layer 370 may be made of inorganic insulating materials, such as a silicon nitride (SiNx) or a silicon oxide (SiOx). The upper insulating layer 370 may be formed to cover an upper side and a lateral side of the roof layer 360. The upper insulating layer 370 serves to protect the roof layer 360 made of an organic material and may be omitted.

The upper insulating layer 370 may contact the lower insulating layer 350 protruding more than the roof layer 360 in the region where the inlet 307 is provided. Further, the upper insulating layer 370 may have a stepwise cross-section by a step between the region contacting the lower insulating layer 350 and the region covering the roof layer.

Further, the upper insulating layer 370 may be connected to the lower insulating layer 350.

A capping layer 390 may be formed on the upper insulating layer 370. The capping layer 390 is formed to cover the inlet 307 for exposing part of the microcavity 305. That is, the capping layer 390 may seal the microcavity 305 so that the liquid crystal molecules 310 formed in the microcavity 305 do not come to the outside. The capping layer 390 contacts the liquid crystal molecules 310, and thus may preferably be made of a material which does not react to the liquid crystal molecules 310. For example, the capping layer 390 may be made of parylene.

The capping layer 390 may also be made of a multilayer such as a double layer and a triple layer. The double layer may be formed of two layers which are made of different materials. The triple layer is formed of three layers, in which materials of the layers adjacent to each other are different from each other. For example, the capping layer 390 may include a layer made of the organic insulating material and a layer made of the inorganic insulating material.

Although not shown, a polarizer may be further formed on the upper and lower sides of the display device. The polarizer may include a first polarizer and a second polarizer. The first polarizer may be attached to the lower side of the substrate 110 and the second polarizer may be attached to the capping layer 390.

As described above, according to an embodiment, the first display unit 1000 and the second display unit 2000 having curvatures may combine to form a wide curved screen thorough a direct connection of their first edges when the display device is in an open state. Advantageously, substantially immersive and/or satisfactory user viewing experience may be attained.

According to an embodiment, the display device may be closed (or folded) such that the display units 1000 and 2000 may overlap each other to minimize a width of the display device and to conceal the image display sides of the display units 1000 and 2000. Advantageously, satisfactory portability of the display device may be attained, and undesired damage to the image display sides may be minimized or substantially prevented.

According to embodiments, contact units 5001 and 5002 positioned at second edges of the first display unit 1000 and the second display unit 2000 may prevent direct collision between the display units 1000 and 2000 and/or may securely coupling the display units 1000 and 2000 to each other when the display device is in a closed state. Advantageously, undesired damage to the display units 1000 and 2000 may be minimized or substantially prevented.

According to an embodiment, the first display unit 1000 and the second display unit 2000 are curved so an inner space is provided to accommodate a peripheral device, e.g., the input device 6000, when the display device is closed. Advantageously, satisfactory compactness and portability of elements of the display device may be attained.

While embodiments have been described, it is to be understood that possible embodiments are not limited to the described embodiments. Embodiments are intended to cover various modifications and equivalent arrangements applicable within the spirit and scope of the appended claims.

What is claimed is:

1. A display device comprising:
a first display unit and a second display unit each having a curvature,
wherein the first display unit and the second display unit are connected to each other at a first edge,
an opening and closing unit for opening and closing the first display unit and the second display unit is formed at a second edge, and
at least one of the first display unit and the second display unit includes
a substrate,
a pixel electrode provided on the substrate,
a roof layer facing the pixel electrode; and
a liquid crystal layer formed with a plurality of microcavities including liquid crystal molecules between the pixel electrode and the roof layer.

2. The display device of claim 1, wherein
while the first display unit and the second display unit are closed,
displaying sides of the first display unit and the second display unit face an internal side, and
rear sides of the first display unit and the second display unit have an externally exposed bag shape.

3. The display device of claim 2, wherein
while the first display unit and the second display unit facing each other are closed,
a space is formed between the first display unit and the second display unit, and
an input device is received in the space.

4. The display device of claim 1, wherein
while the first display unit and the second display unit are opened, and
a displaying side of the first display unit is connected to a displaying side of the second display unit to form a displaying side.

5. The display device of claim 4, wherein
a driver is provided on a first edge connected to the first display unit and the second display unit and a power supply is provided on the first edge connected to the first display unit and the second display unit.

6. The display device of claim 5, wherein
the driver and the power supply are formed in a bar shape on the first edge of the first display unit and the second display unit, and
the driver and the power supply become a support for fixing the display device when the first display unit and the second display unit are opened.

7. The display device of claim 6, wherein
first sides of the driver and the power supply are connected to each other, and
the driver is separated from the power supply with a predetermined angle therebetween to fix the opened first display unit and the second display unit.

8. The display device of claim 1, wherein
the first display unit and the second display unit are connected to each other on a first edge by a hinge.

9. The display device of claim 1, wherein
the first display unit and the second display unit further includes a common electrode.

10. The display device of claim 1, wherein
the roof layer forms a partition wall portion provided between a liquid crystal layer formed with the microcavities.

11. A display device comprising:
a first display unit, which comprises a first pixel electrode, wherein the first pixel electrode is associated with a first pixel of the display device;
a second display unit, which comprises a second pixel electrode, wherein the second pixel electrode is associated with a second pixel of the display device, wherein the first pixel electrode overlaps the second pixel electrode when the display device is in a closed state of the display device, and wherein a first edge of the first display unit directly contacts a first edge of the second display unit when the display device is in an open state of the display device;
a first contact unit, which directly contacts a second edge of the first display unit; and
a second contact unit, which directly contacts a second edge of the second display unit, wherein the first contact unit directly contacts the second contact unit when the display device is in the closed state of the display device, and wherein the first contact unit is spaced from the second contact unit and is connected through the first display unit and the second display unit to the second contact unit when the display device is in the open state of the display device.

12. The display device of claim 11,
wherein the first display unit comprises a first liquid crystal layer,
wherein the second display unit comprises a second liquid crystal layer, and
wherein the first liquid crystal layer and the second liquid crystal layer are positioned between the first pixel electrode and the second pixel electrode when the display device is in the closed state of the display device.

13. The display device of claim 11 comprising a user-input device, which is positioned between the first display unit and the second display unit when the display device is in the closed state of the display device.

14. The display device of claim 11,
wherein the second edge of the first display unit directly contacts the second edge of the second display unit when the display device is in the closed state of the display device, and
wherein the second edge of the first display unit is spaced from the second edge of the second display unit when the display device is in the open state of the display device.

15. The display device of claim 11 comprising a driver, which overlaps each of the first edge of the first display unit and the first edge of the second display unit.

16. The display device of claim 15 comprising a power supply, which is oriented parallel to the driver when the display device is in the closed state of the display device and is oriented at an acute angle or a right angle with respect to the driver when the display device is in the open state of the display device.

17. The display device of claim 16 comprising a hinge, wherein the first display unit is connected through the hinge to the second display unit, and wherein the driver is positioned between the hinge and the power supply when the display device is in the closed state of the display device.

18. The display device of claim 15, wherein the first display unit is curved between the driver and the first contact unit.

19. The display device of claim 11,
wherein the first pixel electrode is spaced from the second pixel electrode by a first distance when the display device is in the closed state of the display device,
wherein the first pixel electrode is spaced from the second pixel electrode by a second distance when the display device is in the open state of the display device, and
wherein the first distance is less than the second distance.

20. A display device comprising:
a hinge;
a first display unit, which comprises a first pixel electrode, wherein the first pixel electrode is associated with a first pixel of the display device;
a second display unit, which is connected through the hinge to the first display unit and comprises a second pixel electrode, wherein the second pixel electrode is associated with a second pixel of the display device, and wherein the first pixel electrode overlaps the second pixel electrode when the display device is in a closed state of the display device;
a first contact unit, which is connected through the first display unit to the hinge; and
a second contact unit, which is connected through the second display unit to the hinge, wherein the first contact unit directly contacts the second contact unit when the display device is in the closed state of the display device, and wherein the first contact unit is spaced from the second contact unit and is connected through the first display unit and the second display unit to the second contact unit when the display device is in an open state of the display device.
